(19) United States
(12) Patent Application Publication
(10) Pub. No.: US 2018/0027749 A1
(43) Pub. Date: Feb. 1, 2018

(54) Plant Framing System

(71) Applicant: Brenda Marie Frew, Prattville, AL (US)

(72) Inventor: Brenda Marie Frew, Prattville, AL (US)

(21) Appl. No.: 15/224,484

(22) Filed: Jul. 29, 2016

(51) Int. Cl. A01G 9/02; A01G 7/04; A01G 27/00

(52) U.S. Cl. CPC A01G 9/02; A01G 27/00; A01G 7/045

(57) ABSTRACT

A detachable decorative plant surround system with access avenues for water or lighting applications that can be continuously connected. The plant surround has a center opening from which a plant can grow through and a top surface that slopes inward and downward to the said center opening for water collection. The body of the plant surround can be constructed of any material suitable for maintaining the described structure and can be any shape or size with a translucent, grooved, smooth or textured surface and colorfully decorated. The snap together mechanism allows the plant surround to separate and snap together repeatedly around any size plant. The said snap together mechanism has receiving ports on one side of the plant surround and inserting posts on the opposite side securing the plant surround together. The access avenues on the underside of the plant surround support optional water or lighting applications and the side openings allow the water or lighting to connect to multiple plant surrounds. The plant surround can be used indoors or outdoors in a garden/landscape or a pot/planter.

### BACKGROUND OF THE INVENTION

This invention relates generally to plant surround devices and more specifically to detachable, multi-purpose surround frame systems adaptable to multiple plants. The present invention is of particular use to gardeners, landscapers and florist and provides interchangeable water or lighting applications, aesthetic value and a snap together body design.

Gardeners and plant enthusiasts all over the world are always looking for new and exciting ways to maintain and decorate their gardens, pots, landscapes and showcase their plants. The present invention allows for indoor or outdoor use, several different interchangeable applications of lighting or water and provides a two piece snap together body design for easy, repeated application and removal.

The invention (herein referred to as the plant frame) provides a snap together body design that allows the plant frame to surround any size plant. Other known designs force the gardener to struggle with limbs, leaves and flowers, potentially harming the plant. The plant frame unsnaps and is placed around the base of a plant and snaps back together and unsnaps for removal, thus solving any issues with the size of the desired plant to be surrounded. Known prior art may be placed around a small plant, but after the plant grows, presents an issue of removing the surround from, the now larger plant. The plant frames snap together design eliminates the application and removal issues.

The plant frame's body design provides a slightly sloping top surface and access avenues on the underside for water or lighting applications. The plant frame's sloping top surface allows natural rain water collection, directing water to the center opening, supplying water directly to the plants root system. The plant frame's sloped top surface assists in the watering needs of the surrounded plant. However, the plant frames underside body design with access avenues, allows for a watering application to be applied in drought or desert conditions and may be connected continuously to multiple plant frames. The plant frame with the water application in place insures the survival of the surrounded plant, thus solving water depravation issues.

The aforementioned underside body design of the plant frame's access avenues for water or lighting provide an interchangeable option. In an environment where the watering application may not be necessary, a lighting application may be applied for a nighttime display. The lighting application may be connected continuously to multiple plant frames. The optional, interchangeable water and lighting element of the plant frame provides different effects in one apparatus, thus saving the user from purchasing another item to obtain a different effect.

It would be expedient, therefore, to provide an improved apparatus and method for applying and removing a plant surround system that prevents potential harm to the surrounded plant with interchangeable water and lighting option those possess continuous connection abilities that ensures survival of surrounded plants and minimizes expenses.

### SUMMARY OF THE INVENTION

In view of the foregoing, it is a primary object of this invention, herein referred to as the plant frame, to provide a decorative multipurpose plant surround for indoor or outdoor use with a two piece snap together body design which eliminates the disadvantages of other plant surround devices.

Further, it is also a primary object of the plant frame to provide an underside body design with access avenues that support interchangeable water or lighting applications with continuous connection capabilities between multiple plant frames.

According to an embodiment of the invention, a plant frame comprises a decorative sloping top surface with a center opening for a plant to grow through, a two piece snap together body and the underside access avenues for water or lighting applications. Said two piece snap together body design facilitates a safe application and removal process. Said two piece body unsnaps and is placed at the base of the plant and snaps together allowing the desired plant to grow through said center opening. Said underside access avenues allow for water or lighting applications and provide optional continuous connections between multiple plant frames.

An advantage of the plant frame is the provisions of a two piece snap together body design that allows the plant frame to surround any size plant and eliminates damaging the plant in the application and removal process.

Another advantage of the plant frame is the provision of underside access avenues, which allows the plant frame to have water tubing applied in conjunction with a drip device to assist with the surrounded plants survival. The water tubing may be continuously connected to multiple plant frames or singularly and then to a water timer or directly to a water faucet.

Another advantage of the plant frame is the provision of an underside access avenue that allows multiple lighting application options. The lighting application provides for a translucent body glow, a top surface cutout light display or a said center opening plant illumination. The lighting may be connected continuously to multiple plant frames or singularly and powered by solar or an electric source.

A further advantage of the plant frame is the provision of underside access avenue which provides the option for water or a lighting application as an interchangeable aspect. A water or lighting application may be removed and replaced with the opposite effect, avoiding the added expense of purchasing another device possessing a different effect.

Another advantage of the plant frame is it's versatility for indoor or outdoor use and can surround a plant on the ground/landscape or in a pot/planter.

Another advantage of the plant frame is the sloping top surface which provides assistance with natural rain water collection directed to the said center opening, feeding the surrounded plant at its root base.

### BRIEF DESCRIPTION OF THE DRAWINGS

The forgoing and other objects, features, and advantages of the present invention will be apparent from the following more particular description of preferred embodiments as illustrated in the accompanying drawings in which reference characters to the same part throughout the various views. The drawings are not necessarily to scale, emphasis instead being placed upon illustrating the principles of the invention.

FIG. 1A is a perspective view of an embodiment of the present invention designed for use as a multipurpose plant surround of the top surface as it would display on a surface surrounding a plant.

FIG. 1B is a perspective view of an embodiment of the present invention designed for use as a multipurpose plant surround in view of the top surface as it would display on a surface surrounding a plant displaying possible lighting cutouts.

FIG. 1C is a perspective view of an embodiment of the present invention designed for use as a multipurpose plant surround with the body separated.

FIG. 2A is a perspective view of an embodiment of the present invention designed for use as a multipurpose plant surround specifically detailing the main structural parts of the underside.

FIG. 2B is a perspective view of an embodiment of the present invention designed for use as a multipurpose plant surround specifically detailing the water and lighting access avenue areas of the underside.

FIG. 2C is a perspective view of an embodiment of the present invention designed for use as a multipurpose plant surround from the underside, separated.

FIGS. 3A & 3B is a perspective view specifically detailing the snap together mechanism, detached.

FIGS. 4A & 4B is a perspective view specifically detailing the side access openings for the water and light, right side up and of the underside means for continuous connection.

FIG. 5 is a perspective view specifically demonstrating the water application in place using Alpha labels.

FIGS. 6A & 6B is a perspective view specifically demonstrating the optional lighting applications in place using Alpha labels.

FIG. 7 is a perspective view demonstrating different applications and continuous connections.

### DETAILED DESCRIPTION OF THE DRAWINGS

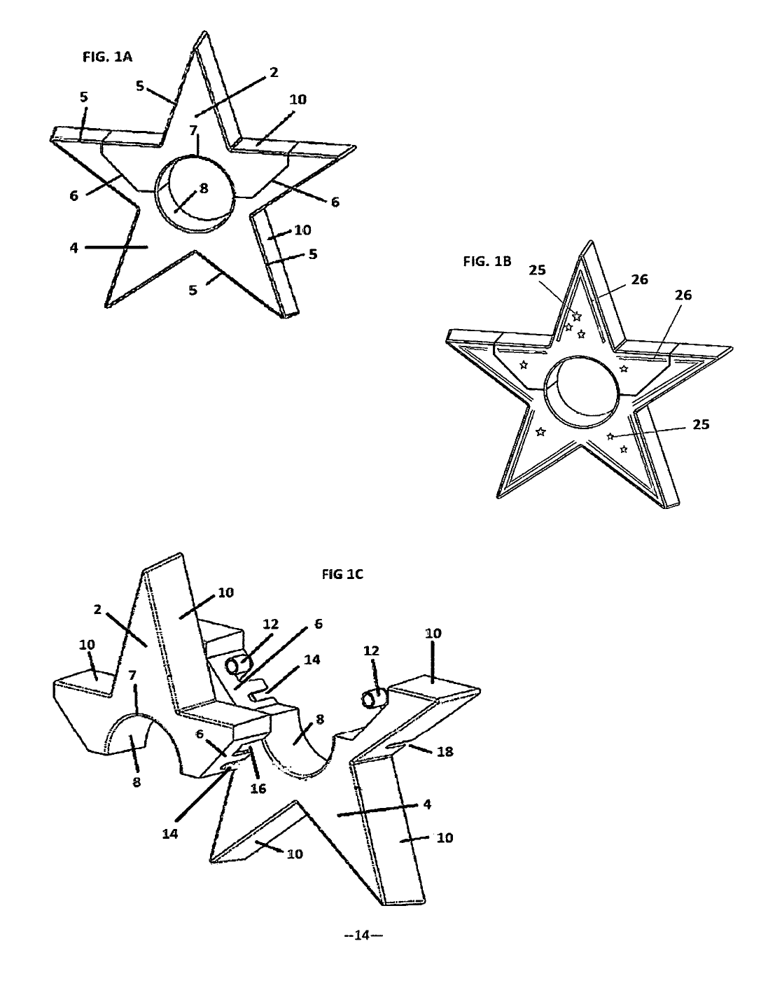

In accordance with an embodiment of the invention, in FIG. 1A of the present invention (herein after referred to as the Plant Frame) an upper section 2 and a lower section 4 of the plant frame is shown in the complete form as it would appear in a garden, pot or landscape. A center opening 8 and a top center opening perimeter edge 7 of said center opening 8 provides means for a plant to grow through. The top surface of the plant frames said upper section 2 and said lower section 4 slopes slightly inwardly and downwardly from a top perimeter edge 5 to said top center opening perimeter edge 7 of said center opening 8 means for natural water collection. A separation wall 6 means for said upper section 2 and said lower section 4 to separate, allowing the Plant Frame the ability to surround any size plant. A side wall 10 extends from the said top perimeter 5 to the surface which the plant grows from and completely around the design. FIG. 1A is in the form, as it would display the translucent lighting, illuminating throughout the entire body of the Plant Frame. In FIG. 1B lighting cutouts 25 and 26, display a suggestive design for the Plant Frame with the lighting applied to the underside. The light would shine through the cutouts 25 &26 for an evening display.

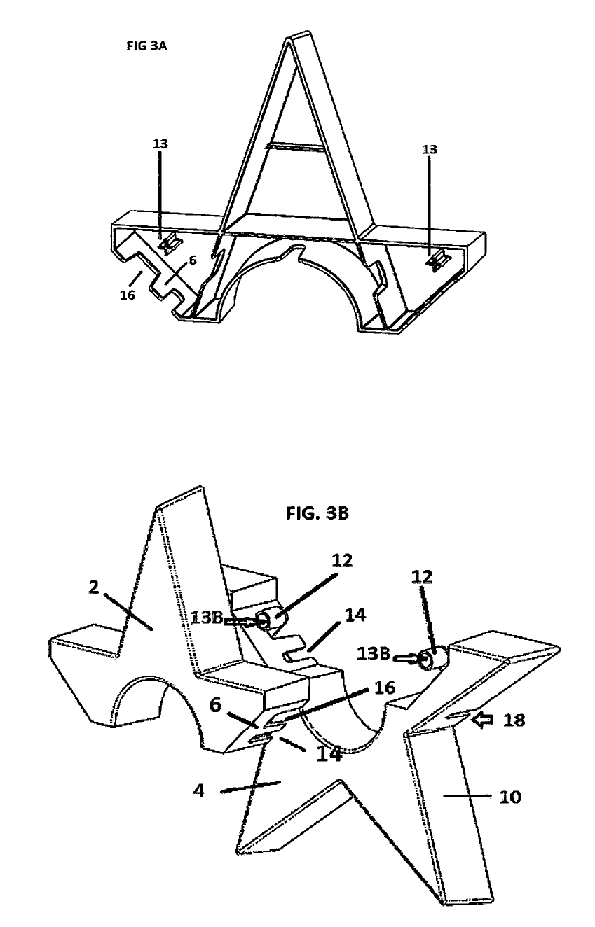

FIG. 1C is a top/side view of said upper section 2 and said lower section 4, separated. A receptacle arm 12 means for receiving a snap together Post 13 (see FIGS. 3A & 3B) of the invention's snap together mechanism, joins said upper section 2 with said lower section 4. A cutout 16 means for said receptacle arm 12 to extend across said separation wall 6 and snap together said upper section 2 with said lower section 4. An access avenue 14 provides for a water or lighting application to pass through said separation wall 6 allowing water or lighting to be present in the underside plant frame body cavities. A side access 18 means for receiving and exiting water or lighting applications in said side wall 10, said side access 18 is provided in the embodiment on both sides of the plant frame opposite of each other. Said side access 18 allows water or lighting applications to enter one side and exit the opposite side through said side access 18 providing the means for continuous connection between multiple Plant Frames.

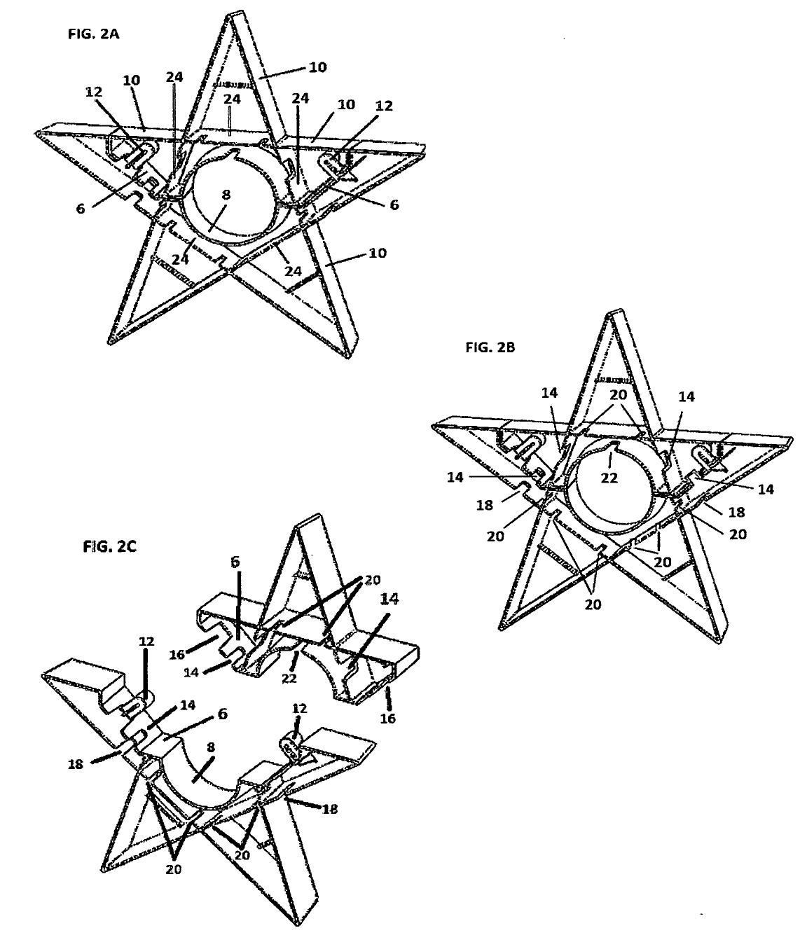

FIG. 2A shows the underside of the Plant Frame with specific detailing aspects of supporting walls. The support walls 24 provide structural support and provide for water and lighting access avenues. Said separation walls 6 allow body separation and supports the snap together features and access avenues. Said side wall 10 supports the perimeter of the body and allows for side access.

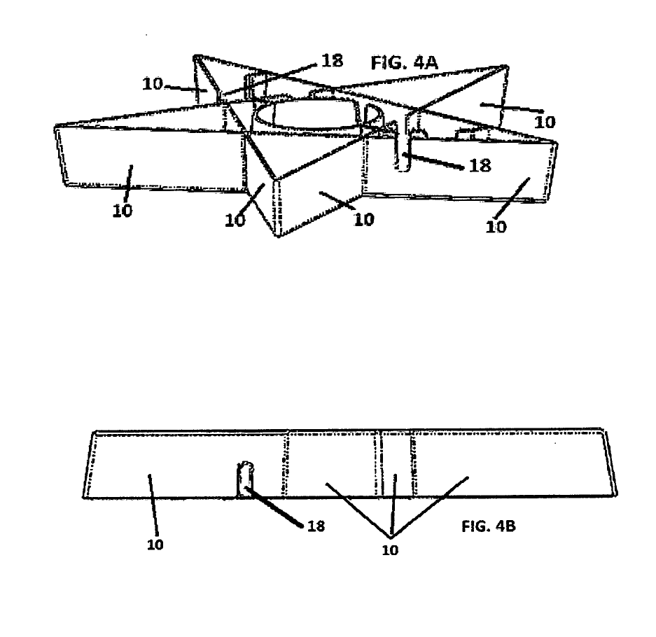

FIG. 2B shows the underside of the Plant Frame with specific detailing aspects of the water and light application access avenues. Access avenues 20 are designed for lighting only, access avenues 18, 14 & 22 are for water or lighting. Said side access 18 is displayed on opposite sides of the Plant Frame in said wall 10, allowing the water or light applications to enter one side and exit the opposite side, for continuous connections. (see FIG. 5) The water access avenues 18, 14 and 22 allow the water supply to flow through said side access 18 in said side wall 10, through said access avenue 14 in said separation wall 6, through said access avenue 14 in said wall 24 and through the access avenue 22 in center opening 8, to supply the plant with water at the root base. The water source may end in said opening 8 or may “T” off continuing through the plant frame in an opposite direction through said access avenue 14 in said wall 24, through said access avenue 14 in said separation wall 6 and out said side access 18 to another Plant Frame (see FIG. 5 for further clarification).

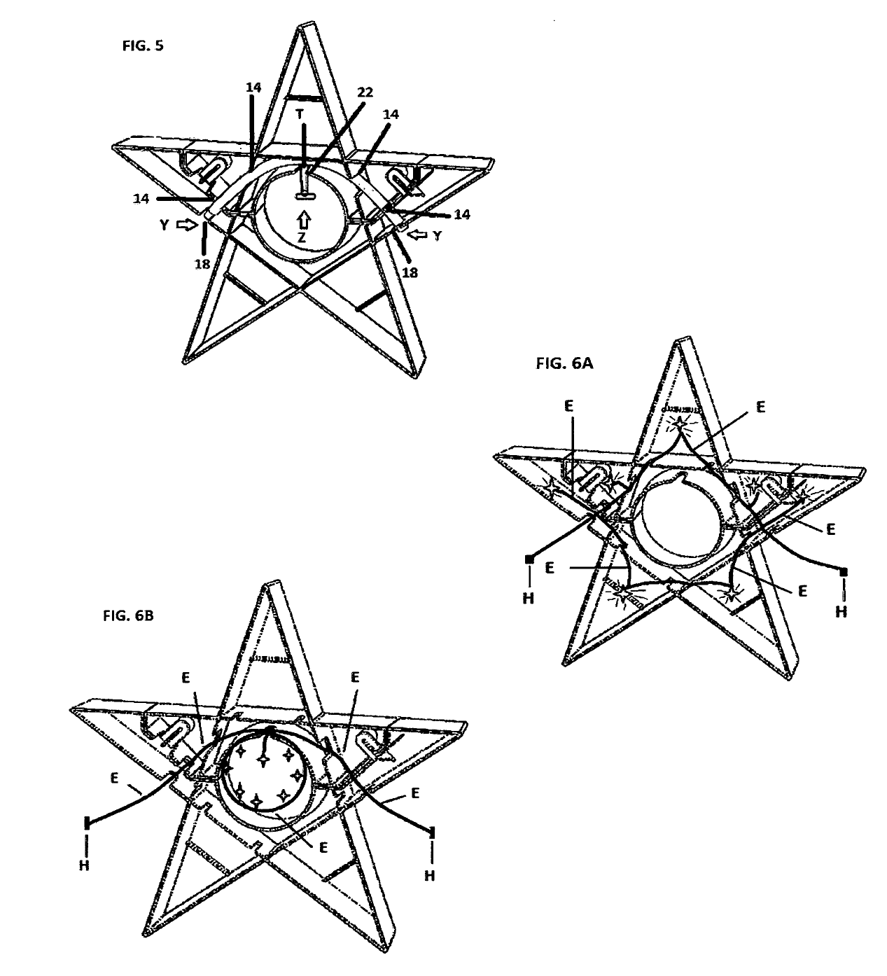

FIG. 2B also specifically details the lighting access avenues. The lighting access avenues are 18, 14, 20 and 22, and support multiple lighting applications. One optional application; the light wiring and lights enters said side access 18 in said side wall 10 proceeding through said access avenues 14 in said separation wall 6, through said access 14 in said wall 24, utilizing said access avenues 20 to illuminate the cavities in the underside of the Plant Frame (see FIG. 6A, E wires) The for mentioned optional lighting application is beneficial for use with a translucent body style or the cut out design as displayed in FIG. 1B.

Other optional lighting applications are a single light in center opening 8 or a ring of lights in center opening 8. (see FIG. 68). The light wiring enters said side access 18 in said side wall 10 through said access avenue 14 in said separation wall 6, through said access avenue 14 in said wall 24, through said access avenue 22 into said center opening 8 with a single light F (see FIG. 68) or multiple lights G. Said side access 18 in said side wall 10 allows the lighting application to enter one side of the Plant Frame and exit the opposite side utilizing said side access 18 in said side wall 10 and connect continuously to other Plant Frames (see FIGS. 6A & 6B, H).

FIG. 2C shows all the aspects from FIGS. 2A & 2B of the Plant Frame separated, exposing said separation wall 6 and said cutout space 16, for the snap together said receptacle arm 12. Said access opening 18 is viewed on both sides of the Plant Frame as well as said access avenue 14, where it lines up together on both sides in said separating wall 6.

FIGS. 3A & 38 are specifically detailed to address the snap together parts. FIG. 3A is the underside view of said upper section 2, revealing the snap together posts 13 and the receptacle arm cutout 16 in said wall 6. FIG. 38 displays a top/side view of said upper section 2 and said lower section 4 separated, revealing said receptacle arm 12 and said cutout 16 in said wall 6. Said cutout 16 allows the said receptacle arm 12 to extend from said lower section 4, across said wall 6, utilizing said cutout 16 to snap together with said snap together post 13 into the receiver 138.

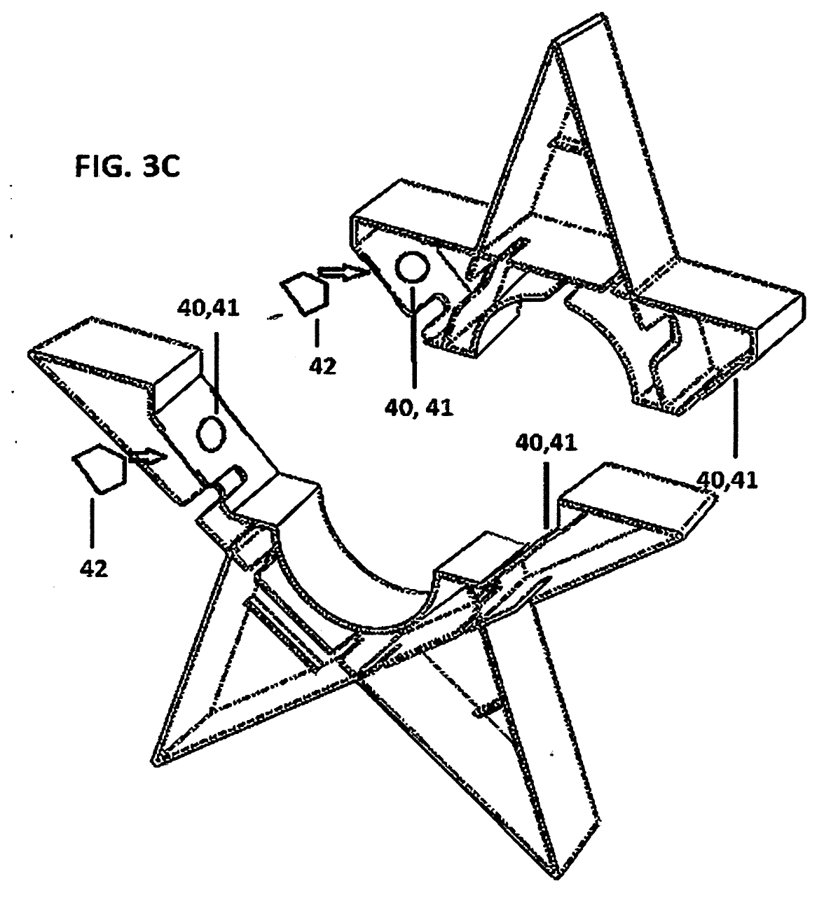

FIGS. 4A & 4B are a side view specifically displaying the Plant Frame upside down with said access opening 18 in said wall 10. FIG. 4B is a side vies of the plant frame as it would appear on a surface upright, displaying said access opening 18 in said side wall 10.

FIG. 5 displays the water supply to flow through said side access 18 in said side wall 10, through said access avenue 14 in said separation wall 6, through said access avenue 14 in said wall 24 and through the access avenue 22 in center opening 8, to supply the plant with water at the root base. The water source may end in said opening 8 or may “T” off continuing through the plant frame in an opposite direction through said access avenue 14 in said wall 24, through said access avenue 14 in said separation wall 6 and out said side access 18 to another Plant Frame.

FIG. 6A displays an optional lighting application; the wire E is beneficial for use with a translucent body style or the cut out design as displayed in FIGS. 1B and H is the optional continuous connection.

FIG. 68 displays other optional lighting applications with a single light in said center opening 8 or a ring of lights in said center opening 8 and the optional continuous connection.

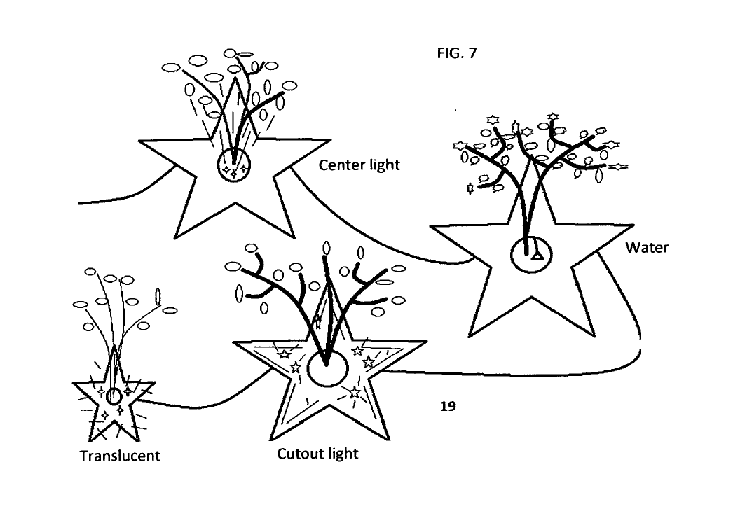

FIG. 7 is a display of different applications continuously connected.

1. A multipurpose detachable plant surround system comprising:
a decorative two piece body having top and underside surfaces and a means of detaching using a snap together mechanism allowing the apparatus to surround any size plant with a center opening for a plant to grow through; underside access avenues for lighting and water applications and side access openings for continuous connection of lighting or water applications between multiple plant surrounds.

2. The apparatus of claim 1, wherein said decorative two piece body's top surface is slopped inward and downward directing water to the said center opening.

3. The apparatus of claim 1, wherein said decorative two piece body can be constructed of any material suitable of supporting the described structure or the apparatus.

4. The apparatus of claim 1, wherein said decorative two piece body possesses a separation wall means for separating the apparatus allowing safe application and removal from around a plant.

5. The apparatus of claim 1, wherein said decorative two piece body is for use indoors or outdoors and on the ground in landscape/garden or in a planter/pot.

6. The apparatus of claim 1, wherein the said center opening can be any shape or size.

7. The apparatus of claim 1, wherein provides said underside access avenues provide side access openings for interchangeable water and lighting applications to be applied for continuous connection between plant surrounds.

8. The apparatus of claim 1, wherein said underside access avenues allow water tubing to be applied through the said access avenues to the said center opening to supply the surrounded plant with water in drought or desert conditions and aid in the plants survival.

9. The apparatus of claim 1, wherein said underside access avenues allow lighting applications in different configurations to achieve different effects such as, a translucent glow or through light escaping top surface cutouts when the light is present in the underside body cavities or a center plant illumination when single light or a group of lights are present in the said center opening.

10. The apparatus of claim 1, wherein said side access openings allow the water or lighting applications to enter the underside and flow through the said access avenues in the desired application and exit the opposite side out the said side access opening and connect to another apparatus.

11. The apparatus of claim 1, wherein said snap together mechanism on the underside comprises receptacles on one side of said decorative two piece body for accepting inserting posts on the opposite side of said decorative two piece body or alternative products such as velcro, magnets or clips connecting the two sides together allowing the apparatus to be applied and removed repeatedly from around desired objects.

12. The apparatus of claim 1, wherein said decorative two piece body's top surface may be any shape or size and may possess a smooth, translucent, textured or grooved surface.
